(19) United States
(12) Patent Application Publication
(10) Pub. No.: US 2024/0418639 A1
(43) Pub. Date: Dec. 19, 2024

(54) PROCESS AND APPARATUS FOR ANALYZING A GAS SAMPLE BY ANALYZING THE BEHAVIOR OF A SYSTEM

(71) Applicant: Dräger Safety AG & Co. KGaA, Lübeck (DE)

(72) Inventor: Sebastian DRAACK, Lübeck (DE)

(21) Appl. No.: 18/738,367

(22) Filed: Jun. 10, 2024

(30) Foreign Application Priority Data
Jun. 14, 2023 (DE) 10 2023 115 476.1

(51) Int. Cl. G01N 21/3504; G01N 21/17; G01N 29/032; G01N 29/46

(52) U.S. Cl. CPC G01N 21/3504; G01N 29/032; G01N 29/46; G01N 2021/1789

(57) ABSTRACT

A gas measuring device (100) and a gas measuring process analyze a gas sample (Gp) from a spatial area (B) for target gas (Zg). A measurement chamber (2) is filled with the gas sample and a reference chamber (3) is filled with a reference gas (Rg). A radiation source (1) emits radiation [eW, s(t)] into the measurement chamber and the reference chamber. The target gas attenuates the radiation. A measurement detector (4) measures a measurement signal [y(t)], a reference detector (5) measures a reference signal [x(t)]. Both signals correlate with the radiation intensity in the respective chamber. A system behavior [G(s)] of a system model is calculated that is excited with the reference signal [x(t)] as the input signal and generates the measurement signal [y(t)] as the output signal in response. Information (Erg) about the target gases in the gas sample is determined by evaluating the system behavior.

### CROSS REFERENCE TO RELATED APPLICATIONS

This application claims the benefit of priority under 35 U.S.C. § 119 of German Application 10 2023 115 476.1, filed Jun. 14, 2023, the entire contents of which are incorporated herein by reference.

### TECHNICAL FIELD

The invention relates to a gas measuring device (gas detection device/gas detector) and a gas measuring process (gas detection process) which are capable of analyzing a gas sample for several target gases, wherein the gas sample originates from a spatial area (spatial region/space) to be monitored. In many cases, the analysis comprises determining which target gases are present in the gas sample and at what respective target gas concentration.

### BACKGROUND

Gas measuring devices comprising a radiation source and a measurement chamber have become known. A gas sample to be analyzed enters the measurement chamber. Radiation emitted by the radiation source penetrates at least once the measurement chamber. Every target gas in the measurement chamber absorbs a part of the radiation that penetrates the measurement chamber. A detector on the measurement chamber measures an indicator of the intensity of the incident radiation or another indicator of the intensity of the radiation in the measurement chamber. This intensity correlates with the respective target gas concentration which is to be determined. In one embodiment, the invention also uses this principle.

### SUMMARY

It is an object of the invention to provide a gas measuring device and a gas measuring process which are capable of determining the respective concentration of several target gases in a gas sample from a spatial area to be monitored with greater operational reliability than known devices and processes.

The problem is solved by a gas measuring device with features disclosed herein and by a gas measuring process with features disclosed herein. Advantageous embodiments are disclosed herein. Advantageous embodiments of the gas measuring device according to the invention are, where appropriate, also advantageous embodiments of the gas measuring process according to the invention and vice versa.

The gas measuring device according to the invention and the gas measuring process according to the invention are capable of automatically analyzing a gas sample. This gas sample originates from a spatial area.

The spatial area and therefore the gas sample can have at least one target gas to be detected, often several target gases. A “target gas” is understood to be a gas which can occur in the spatial area, and which is to be detected, in particular a combustible and/or toxic and/or otherwise harmful gas or oxygen or carbon dioxide or an anesthetic. Of course, other substances can occur in the spatial area and thus in the gas sample that do not need to be detected in a particular application, such as water droplets or dust particles. Which target gases to be detected can therefore depend on the application.

The gas measuring device according to the invention and the gas measuring process according to the invention are capable of providing target gas information. This target gas information comprises at least one of the following:
an indicator of the summed concentrations of the target gases to be detected in the gas sample—if only one target gas is present, the concentration of this target gas in the gas sample is supplied,
which target gases are present in the gas sample,
for at least one target gas, preferably for each target gas, an indicator for the respective quantity or for the concentration of this target gas in the gas sample.

Of course, the target gas information can also include the information that no target gas to be detected is present in the gas sample with a concentration or quantity above a predefined lower limit.

The gas measuring device according to the invention comprises a gas measuring unit (gas detection unit). The gas measuring unit comprises a measurement chamber and a reference chamber. The measurement chamber comprises the gas sample or is filled with the gas sample to be analyzed. The reference chamber is filled with a reference gas. This reference gas is free of any target gas to be detected. It is possible that the reference chamber has a vacuum. Preferably, the reference chamber is sealed fluid-tight against the area to be monitored and against the gas sample in the measurement chamber.

The gas measuring unit according to the invention further comprises a radiation source, a measurement detector, and a reference detector. The gas measuring process according to the invention is carried out using such a gas measuring unit.

The radiation source emits radiation, both into the measurement chamber and into the reference chamber. The radiation is in particular electromagnetic radiation, for example infrared light, or acoustic radiation (sound). The emitted radiation penetrates (passes through) both the measurement chamber and the reference chamber at least once, optionally several times in order to extend the optical path. With regard to the radiation emitted by the radiation source, the two chambers are connected in parallel, i.e. a part of the emitted radiation reaches the measurement chamber without having previously penetrated the reference chamber and, conversely, a part of the radiation reaches the reference chamber without having previously penetrated the measurement chamber.

The emitted radiation is sufficiently broadband (wideband). This means that the radiation has a frequency band. Ideally, the energy of the emitted radiation is constant over this frequency band. For at least one target gas to be detected, preferably for each target gas to be detected, the frequency band comprises a frequency band portion. In this frequency band portion, this target gas attenuates at least part of the radiation. This attenuation can be measured. Two different frequency band portions can overlap or be disjoint.

The measurement detector generates a time-resolved measurement signal depending on its measured values. The measurement signal is an indicator of the intensity of the emitted radiation, specifically an indicator of the intensity after the radiation has penetrated at least part of the gas sample in the measurement chamber at least once and impacts (impinges) onto the measurement detector. Preferably, the measurement signal is an indicator of the intensity of the radiation after the radiation has completely penetrated the measurement chamber at least once, optionally several times.

The reference detector generates a time-resolved reference signal depending on the measured values. The reference signal is an indicator of the intensity of the emitted radiation, namely an indicator of the intensity after the radiation has penetrated at least part of the reference gas in the reference chamber and impacts (impinges) onto the measurement detector. Preferably, the reference signal is an indicator of the intensity of the radiation after the radiation has completely penetrated the reference chamber at least once. Preferably, the two signals relate to the same time period and are preferably generated at the same sampling times or at least at the same sampling frequency.

At least when the gas sample contains at least one target gas to be detected and this target gas is therefore also present in the measurement chamber, the emitted radiation is attenuated as it passes through the measurement chamber. The measurement signal that the measurement detector measures is an indicator of the intensity of the radiation in the measurement chamber. A target gas attenuates this intensity. The attenuation of the radiation and thus also the measurement signal correlate with the target gas concentration in the measurement chamber. The emitted radiation that penetrates the reference chamber can be attenuated in the reference chamber, for example due to environmental conditions that affect both the measurement chamber and the reference chamber. The reference signal measured by the reference detector is an indicator of the intensity of the radiation in the reference chamber. In addition, both the measurement signal and the reference signal often depend on states of components of the gas measuring unit, for example on a state of the radiation source or a chamber or a state of an optional dedicated power supply unit.

The gas measuring device also comprises a signal processing unit. The signal processing unit measures an indicator of a system behavior (system response, system characteristics) of a system model (emulator system/theoretical system). This system model is excited (stimulated) with the reference signal as the input signal. In response to this excitation, the system model generates the measurement signal as the output signal. The system behavior therefore describes how the system model reacts to the excitation by the input signal. The signal processing unit calculates the indicator for the system behavior in the time domain or in the frequency domain. Preferably, the signal processing unit calculates the transfer function of the system model in the frequency domain as an indicator of the system behavior.

The above-mentioned target gas information is derived by evaluating the calculated indicator of system behavior. Preferably, the signal processing unit derives the target gas information. It is also possible that the signal processing unit calculates the indicator for the system behavior and a spatially remote evaluation unit derives the target gas information.

One basis of the invention is therefore the following: At least in a time span in which the process steps are carried out once, the gas sample in the measurement chamber can be regarded with sufficient approximation as a linear time-invariant system. The measurement signal y(t) is understood as a system response of this system model to an excitation by the reference signal x(t). An indicator of the system behavior of this system model is calculated. This system behavior correlates with the presence or absence of target gases and with the respective target gas concentration. The indicator for the system behavior can refer to the time domain or the frequency domain.

The invention enables, but does not require, a user to specify a target gas whose concentration is to be determined. Rather, it is sufficient to specify a frequency band, whereby the radiation emitted by a radiation source is attenuated or even completely absorbed in this frequency band by the target gas or one target gas, ideally by each target gas to be detected. Ideally, the radiation has the same energy over the entire frequency band, but this is not necessary.

In many cases, the gas measuring device is able to determine the respective concentration of several target gases. This reduces the risk of a target gas not being detected or a false alarm being triggered.

The invention does not require that the energy and/or a frequency band at which the radiation source emits radiation be varied in order to detect different target gases. The invention also does not require that the gas measuring device comprises several measuring cells and/or wavelength filters for different target gases or is switched over during use in order to be able to detect different target gases in succession, or comprises different measurement detectors.

According to the invention, the radiation emitted by the radiation source is directed both into the measurement chamber and into the reference chamber. Ideally, the time course of the intensity of the radiation that is introduced (emitted) into the measurement chamber coincides with the time course of the radiation that is directed into the reference chamber. The fact that the respective radiation through the two chambers comes from the same radiation source contributes to this desired effect.

According to the invention, an indicator of the system behavior of a system model is calculated. In order to calculate this indicator of the system behavior, the measurement signal and the reference signal are used, i.e. two signals that are measured after the emitted radiation has at least partially penetrated both chambers in parallel and thus the gas sample or the reference gas. Ideally, the radiation source has the same effect on both chambers and the emitted radiation covers a sufficiently broad frequency band. The invention eliminates the need to control the radiation source so that the time course of a variable describing the emitted radiation, e.g. the course of the intensity in a certain frequency band or the course of the frequency response, follows a predetermined course. It is sufficient that the radiation from each target gas to be detected is attenuated sufficiently strongly in at least part of the frequency band.

The radiation source often ages, for example due to wear and tear. In addition, if the gas measuring unit has its own power supply unit, the available electrical energy can decrease in the course of use. The invention makes it possible to analyze the gas sample relatively reliably despite such changes. A key reason for this is that the system model, whose system behavior is calculated, is excited by the reference signal and provides the measurement signal in response to the excitation. These two signals are often influenced in approximately the same way by a change in the radiation source or the power supply unit. If, on the other hand, the system model were to be excited by a signal that describes the intensity of the radiation before the radiation enters the chambers, the system behavior would generally be more dependent on the current state of the gas measuring unit.

Ideally, the reference chamber is free of any target gas to be detected. Ambient conditions, in particular temperature, humidity and pressure, as well as other interfering influences, for example vibrations, on the other hand, have in many cases approximately the same effect on both chambers. Therefore, and because the measurement signal and the reference signal are used, i.e. two measured time courses, the invention compensates to a certain extent for the influence of the ambient conditions. This advantage would not be achieved if the time-varying intensity of the emitted radiation were necessarily used, and it would therefore be necessary to know or measure this intensity occurs before this radiation reaches a chamber. However, the invention does not presuppose that both chambers react completely identically to ambient conditions.

The measurement signal depends on the target gas concentration and usually on environmental influences, in particular temperature, pressure, humidity, and vibrations. In many cases, the system behavior depends relatively little on the environmental influences. The invention eliminates the need to measure or model the influence of an environmental condition or other disturbance variable (noisy variable). In particular, thanks to the invention, it is not necessary to determine an indicator of the system behavior of a system which is excited by an environmental condition or other disturbance signal and, in response to this excitation, provides a portion of the measurement signal, e.g. that portion which is not caused by the target gas concentration. Such a procedure often requires relatively good knowledge of how an environmental condition or other disturbance variable affects the measurement signal. The invention eliminates the need to model such an influence in advance or to measure it during use.

According to the invention, the measurement detector is capable of measuring an indicator of the intensity of the emitted radiation in the measurement chamber. The reference detector is capable of measuring an indicator of the intensity of the emitted radiation in the reference chamber. Different configurations are possible as to which indicator of intensity the two detectors measure in each case.

In one embodiment, emitted electromagnetic radiation passes through both the measurement chamber and the reference chamber at least once completely and strikes (impinges on) a respective associated photodetector. Each photodetector is embedded in a wall of the respective chamber, for example. A measurement photodetector measures an indicator of the intensity of the incident radiation after this radiation has completely penetrated the measurement chamber and thus a gas sample in the measurement chamber at least once and has been attenuated at least in the presence of a target gas in the measurement chamber. Accordingly, a reference photodetector measures an indicator of the intensity of the incident radiation after this radiation has completely penetrated at least once the reference chamber and thus the reference gas.

In many cases, this configuration is relatively insensitive to vibrations, ambient temperature, and ambient pressure. The frequency band and optionally a frequency-dependent intensity of the radiation source can often be set in such a way that water droplets and therefore also the ambient humidity have a relatively small influence on the measurement signal. It is also possible that a respective wavelength filter between the radiation source and the measurement detector and between the radiation source and the reference detector only allows radiation to pass in a wavelength range in which at least one target gas to be detected attenuates radiation.

In another embodiment, the electromagnetic radiation that penetrates the two chambers triggers a physical effect in each chamber. For example, the electromagnetic radiation changes the temperature and/or the pressure in the respective chamber or triggers an acoustically measurable effect. The physical effect that is triggered in the measurement chamber correlates with the intensity of the radiation in the measurement chamber and therefore with the target gas concentration being sought. The measurement detector measures an indicator of the physical effect that the radiation has triggered in the measurement chamber while the radiation penetrates the measurement chamber. The reference detector measures the physical effect caused by the radiation in the reference chamber.

In many cases, such a configuration is relatively insensitive to the light intensity in the surroundings.

According to the invention, radiation emitted by the radiation source penetrates the measurement chamber and the reference chamber. It is possible that the emitted radiation is continuously emitted into both chambers during use. It is also possible that the emitted radiation is alternately directed to the reference chamber or to the measurement chamber. Preferably, the radiation is emitted in pulses to save electrical energy. Preferably, the radiation changes over time its frequency within the frequency band so that the entire frequency band is covered sufficiently evenly.

In one embodiment, the signal processing unit calculates an indicator for the cross-correlation. The cross-correlation describes the similarity between the two signals y(t) (measurement signal) and x(t) (reference signal) in the time domain. In particular, if the radiation source emits radiation with an intensity idealized in the form of a white noise signal, the cross-correlation correlates with the impulse response of the system model (output signal as a reaction to the excitation by the input signal), i.e. with the reaction of the system model just described to an excitation by a Dirac pulse (delta distribution). If the radiation source emits an ideal white noise signal, which is not possible in practice, the cross-correlation is even proportional to this impulse response. In order to come close to a white noise signal, in practice a broadband noise signal with limited energy is preferably emitted. The signal processing unit uses the indicator of the cross-correlation as an indicator of system behavior or calculates the indicator of system behavior using the cross-correlation.

In a preferred embodiment, the signal processing unit transforms the indicator for the cross-correlation from the time domain into the frequency domain. Preferably, a Fourier transformation or an alternative Laplace transformation is used. The respective concentration of each target gas is determined by evaluating the results of the transformation into the frequency domain. Or the signal processing unit calculates the transfer function of the system model in the frequency domain.

This embodiment has in particular the following advantages: As a rule, each target gas to be detected absorbs radiation in at least one specific frequency range. This frequency range often differs from target gas to target gas and is relatively narrow-band. The frequency band in which radiation is absorbed depends on the target gas, i.e. on the type, but ideally not on the target gas concentration. The strength of the attenuation, i.e. the amplitude in this frequency band, on the other hand, depends on the target gas concentration. Therefore, the cross-correlation transformed into the frequency range is preferably analyzed, and thus both the respective type and the respective concentration of each target gas can be measured.

Thanks to the invention, it is often possible to determine both which types of target gases are present in the gas sample and the respective target gas concentration for each type. An important reason is the following: The indicator of system behavior in the frequency domain describes both the amplitude response and the phase response, usually in the complex numerical domain. The amplitude response describes the dependence of the amplitude on the frequency, the phase response the dependence of the phase on the frequency. The phase response often differs from target gas type to target gas type and depends relatively little on the target gas concentration, while the amplitude response strongly depends on the target gas concentration.

In one embodiment, a respective reference phase response and a respective reference amplitude response are specified for several target gases to be detected. Each reference phase response and each reference amplitude response are determined empirically in advance and stored, for example. The system behavior in the frequency domain is compared with each reference phase response and with each reference amplitude response in order to determine which of these target gases is present in the gas sample under investigation and at what concentration. This step can of course yield the result that at least one target gas to be detected is not present at a concentration above a lower limit.

In one embodiment, the following steps are carried out for at least one predetermined target gas, preferably for each predetermined target gas, and for at least one predetermined concentration of this target gas:
The measurement chamber is filled with a reference gas sample. This reference gas sample contains the target gas with the specified concentration. The reference gas sample is free of the or any other target gas. Preferably, this reference gas sample is taken from the spatial area to be monitored.
The system behavior indicator is determined using this reference gas sample and preferably other reference gas samples. This determination provides a reference system behavior indicator for this target gas.
In the step of determining the target gas type and the respective target gas concentrations, the reference system behavior indicator for this target gas is used. Preferably, it is compared with the system behavior indicator, whereby the calculated indicator refers to the gas sample to be tested.

This embodiment makes it possible to compensate for the influence of ambient conditions with even greater reliability. Furthermore, the embodiment eliminates the need to explicitly specify for each target gas the frequency band in which this target gas attenuates radiation.

In one embodiment, the gas measuring device is configured as a portable device that a user carries with them. This portable device further comprises an own power supply unit and an output unit capable of outputting the target gas information in at least one form that can be perceived by a human.

In another embodiment, the gas measuring device is configured as a device that remains in one place during operation (during a period of use). This device, which remains in one place, can also have its own power supply unit, or be connected or connectable to a power supply network. Preferably, the stationary gas measuring device transmits a message to a spatially remote receiver, whereby this message comprises a signal about a measured target gas concentration. Preferably the receiver can output the message.

According to the invention, the gas measuring device comprises the gas measuring unit and the signal processing unit. In one embodiment, the signal processing unit is a component of the gas measuring unit.

In another embodiment, the signal processing unit is a component of a computer unit, whereby this computer unit also belongs to the gas measuring device and is spatially remote from the gas measuring unit. The gas measuring device comprises a first communication unit and the computer unit comprises a second communication unit. With the aid of these two communication units, a data connection is at least temporarily established between the gas measuring unit and the computer unit. This data connection can be used to transmit signals from the gas measuring unit to the computer unit and thus to the signal processing unit and, in one implementation, vice versa, signals from the computer unit to the gas measuring unit.

The signal processing unit receives the measurement signal and the reference signal via this data connection and, depending on the two signals received, calculates the indicator of the system behavior. The signal processing unit or an evaluation unit derive the target gas information. Preferably, the computer unit also comprises an output unit that is able to output the target gas information in at least one form that can be perceived by a human. Optionally, target gas information is transmitted from the computer unit to the gas measuring unit, and an optional output unit of the gas measuring unit outputs the target gas information in at least one form that can be perceived by a human.

In a variation, the signal processing unit on the remote computer unit calculates the indicator for the system behavior, and an evaluation unit of the gas measuring unit derives the target gas information from this.

The embodiment with the remote computer unit makes it possible to provide a very powerful signal processing unit. It is not necessary for this powerful signal processing unit to be part of a gas measuring unit configured as a portable or stationary device. The same computer unit and therefore the same signal processing unit can be connected to several gas measuring units at the same time.

According to the embodiment just described, the remote signal processing unit calculates the indicator for the system behavior. It is possible to implement the signal processing unit on a powerful computer unit.

In a further implementation of this embodiment, the gas measuring unit is able to decide independently of the spatially remote signal processing unit whether or not the gas sample from the spatial area to be monitored comprises at least one target gas to be detected. According to this embodiment, the gas measuring unit comprises an evaluation unit. This evaluation unit determines an indicator of the attenuation caused by the target gas in the measurement chamber. This attenuation affects radiation that is emitted by the radiation source and penetrates the measurement chamber at least once. To determine the attenuation indicator, the evaluation unit uses the measurement signal and the reference signal. If there is no target gas attenuating the radiation in the measurement chamber, the measurement signal ideally matches the reference signal.

This embodiment makes it possible, on the one hand, for the remote signal processing unit according to the invention to calculate and evaluate the indicator for the system behavior and thereby ideally calculate the respective target gas concentration for each target gas present in the gas sample and, on the other hand, for the gas measuring unit to detect a target gas independently of the signal processing unit and preferably warn (alert) a user of the gas measuring unit. This ensures that the user is warned even if the data connection with the remote computer unit is not currently established and even if the calculation and evaluation by the signal processing unit takes a relatively long time.

The invention is described below by means of an embodiment example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a graph showing the transmittance of methane as a function of the wavelength;

FIG. 2 is a graph showing the transmittance of propane as a function of the wavelength;

FIG. 3 is a schematic view of the structure of the gas measuring device of an embodiment example, whereby the signal processing unit is a component of the gas measuring unit; and

FIG. 4 is a schematic view showing another embodiment of the gas measuring device in which the signal processing unit is spatially remote from the gas measuring unit.

### DESCRIPTION OF PREFERRED EMBODIMENTS

Referring to the drawings, in the embodiment examples, the invention is used to examine (monitor) a spatial area (spatial region, space) for several different combustible target gases. The spatial area is, for example, an area of a production plant or transportation facility or the interior of a building or vehicle or aircraft. In one embodiment, the respective concentration of each target gas to be detected is determined, and preferably information about at least one determined target gas concentration is output in at least one form that can be perceived by a human. In another embodiment, an alarm is output if the measured concentration of at least one target gas or the sum of the target gas concentrations is above a predetermined threshold.

The gas measuring device of an embodiment according to the invention comprises a gas measuring unit with two chambers. A “chamber” is understood to be a component which is capable of accommodating a gas and—optionally with the exception of at least one defined opening—is separated from the environment in a fluid-tight manner. One chamber, the measurement chamber, is at least temporarily in a fluid connection with the area to be monitored and is capable of receiving a gas sample to be analyzed from the spatial area to be monitored. The other chamber, the reference chamber, receives a reference gas sample that is free of any target gas. At least when the spatial area is to be monitored for target gases, the reference chamber is separated in a fluid-tight manner from the spatial area and also fluid-tight from the measurement chamber.

The reference gas sample can also originate from the spatial area. The reference gas sample then enters the reference chamber from the spatial area if it is established or for sure that the spatial area currently does not contain any target gas. Preferably, the reference chamber is separated from the spatial area in a fluid-tight manner at least if the spatial area contains or can contain at least one target gas. In one embodiment, it is achieved that the two gas samples in the two chambers have approximately the same temperature and humidity. However, this is not absolutely necessary.

The invention utilizes a principle known from the prior art, namely the following: Various target gases attenuate electromagnetic and/or acoustic radiation. An indicator of the attenuation is the spectral progression (spectral response), expressed as transmittance Tr in %, as a function of the wavelength λ of radiation. The lower the transmittance Tr[λ], the more the target gas attenuates the radiation.

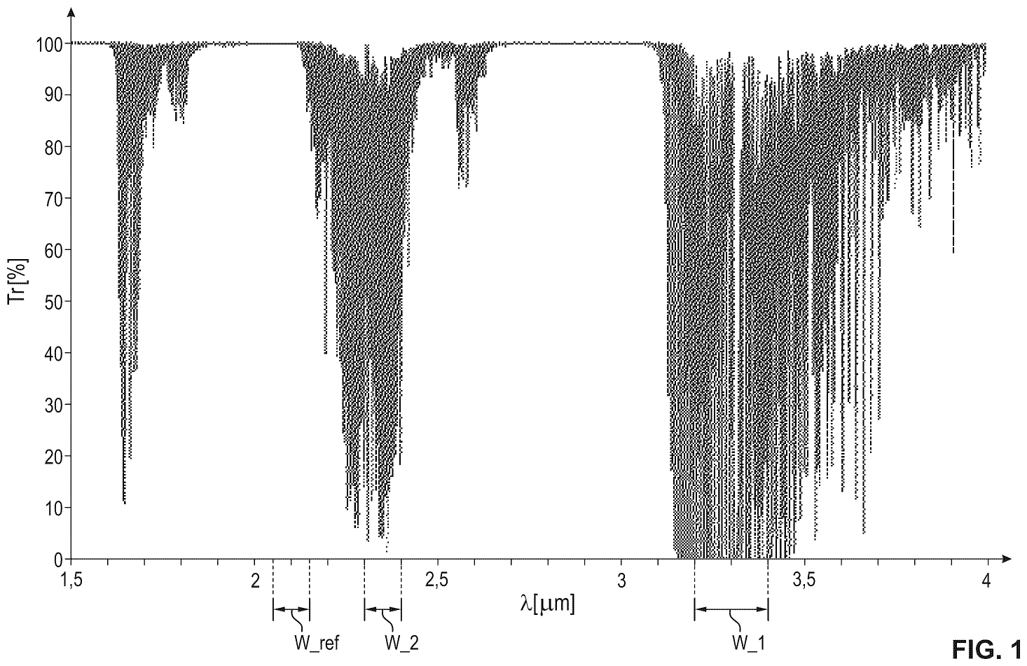

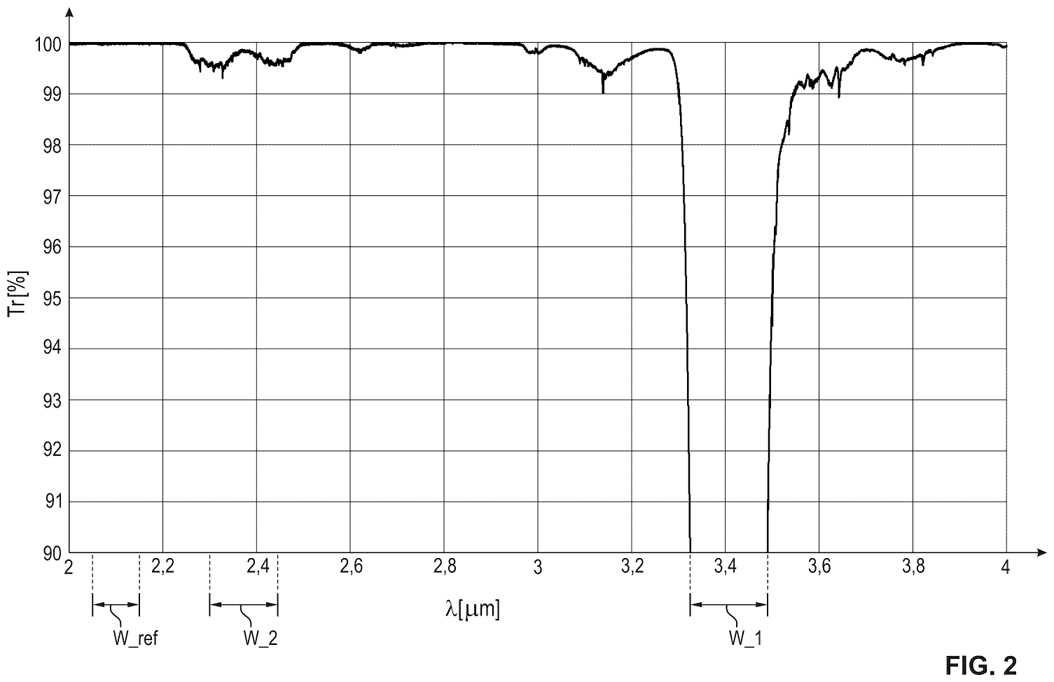

FIG. 1 shows in an exemplary manner the spectral curve for the hydrocarbon methane and FIG. 2 that for propane, in both case at an exemplary concentration of methane or propane. In this example, electromagnetic radiation penetrates a gas sample in a measurement chamber. The wavelength λ in [μm] is plotted on the x-axis and the transmittance Tr in [%] on the y-axis.

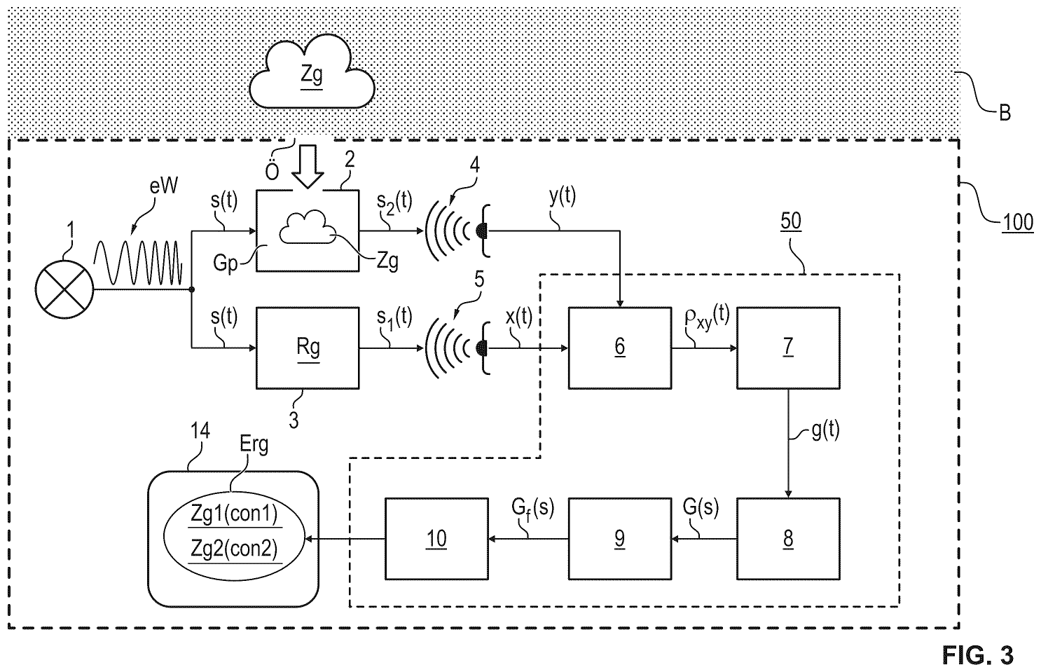

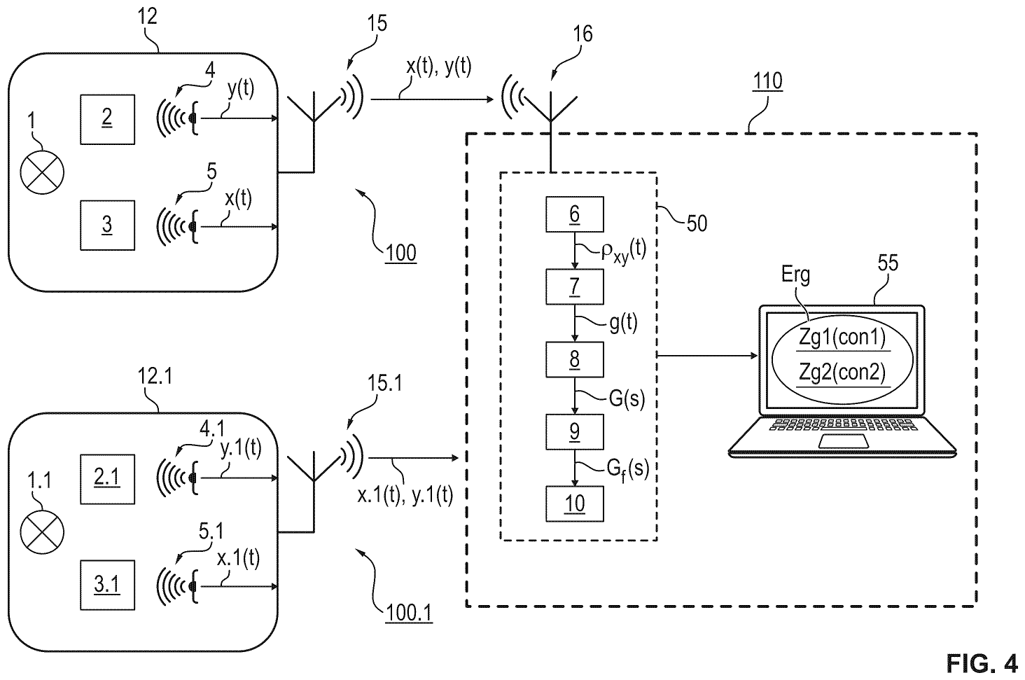

FIG. 3 schematically shows the gas measuring unit 100 of the embodiment example. The gas measuring unit 100 comprises a measurement chamber 2, a reference chamber 3 and a radiation source 1. In the embodiment shown in FIG. 3, the gas measuring unit 100 also functions as the gas measuring device. FIG. 4 shows a different embodiment.

The measurement chamber 2 is at least temporarily in fluid connection with the spatial area B to be monitored via an opening Ö. This area B can have at least one target gas Zg to be detected. A gas sample Gp flows through the opening Ö from the area B into the measurement chamber 2, for example by a pump or other fluid delivery unit sucking in the gas sample Gp and/or by the gas sample Gp diffusing into the measurement chamber 2.

The reference chamber 3 is filled with a reference gas Rg. In the embodiment example, this reference gas Rg is free of any target gas Zg. It is also possible that the reference chamber 3 has approximately a vacuum. However, changing ambient conditions, in particular the ambient temperature, and vibrations have often approximately the same effect on both chambers 2 and 3.

The radiation source 1 emits radiation eW with a frequency band. In one embodiment, the radiation source 1 emits infrared radiation; in another embodiment, the radiation source 1 emits sound or ultrasound. The term “radiation” used below refers in particular to electromagnetic radiation in the visible range, infrared range, or ultraviolet range as well as acoustic radiation (sound and ultrasound).

This radiation eW penetrates (passes through) the measurement chamber 2 at least once, optionally several times. The gas measuring unit 100 uses a principle that is well known from the prior art. The target gas or at least one target gas Zg to be detected in the measurement chamber 2 attenuates the radiation eW in a frequency range. This frequency range generally differs from target gas to target gas and is known in advance. The intensity of the respective attenuation depends on the target gas concentration. However, the frequency range in which the attenuation takes place usually only depends on the target gas type, but not on the target gas concentration. A sensor measures an indicator of the intensity of the incident radiation after the emitted radiation eW has passed through measurement chamber 2 at least once. This indicator of intensity correlates with the target gas concentration.

In the embodiment examples, a set of target gas or target gases is specified which target gases can occur in the area B to be monitored and which are to be detected. The radiation eW emitted by the radiation source 1 is sufficiently broadband. More precisely: The frequency band of the emitted radiation eW is so large (wide) that for each target gas to be detected the frequency band comprises a frequency range in which this target gas attenuates the radiation eW in a measurable way. Therefore, each target gas to be detected causes a measurable attenuation of the radiation eW.

In FIG. 3, the time-varying intensity of the emitted radiation eW is described by a signal s(t). This signal s(t) describes the intensity of the radiation eW before the radiation eW reaches the chambers 2 and 3, i.e. it is an excitation signal. Preferably, the radiation source 1 emits the radiation eW in such a way that the excitation signal s(t) is sinusoidal with a frequency that varies over time (frequency sweep signal). In one embodiment, the radiation source 1 emits the radiation eW in such a way that the excitation signal s(t) is ideally white noise. In reality, white noise can only be achieved approximately. Such approximately achieved white noise is referred to in some claims as white noise.

The emitted radiation eW is directed to the two chambers 2 and 3 in such a way that the intensity of the incident radiation eW for both chambers 2 and 3 can be described with sufficient accuracy by the same excitation signal s(t), see FIG. 3. The radiation eW penetrates both chambers 2 and 3 at least once. The intensity of the radiation eW, which has penetrated the measurement chamber 2 at least once, is described by the signal s₂(t). The intensity of the radiation eW that has penetrated the reference chamber 3 at least once is described by the signal s₁(t).

The gas measuring unit 100 analyzes the gas sample Gp in the measurement chamber 2. For the duration of this analysis, the gas sample Gp is treated as a linear time-invariant system. This assumption is generally justified in particular because the chemical composition of the gas sample Gp in the measurement chamber 2 and also the chemical composition of the reference gas Rg in the reference chamber 3 do not change significantly in the course of the analysis.

The gas measuring unit 100 further comprises a measurement detector 4, which is arranged in or on the measurement chamber 2, and a reference detector 5, which is arranged in or on the reference chamber 3. Both detectors 4, 5 are excited by incident radiation eW and provide a respective time-resolved signal. The measurement detector 4 provides a signal that is referred to as the measurement signal y(t). The reference detector 5 provides a signal, which is referred to as the reference signal x(t). The reference signal x(t) is treated as the input signal for the linear time-invariant system just described and the measurement signal y(t) as the output signal.

A signal processing unit 50 receives the input signal x(t) and the output signal y(t), processes these two signals x(t), y(t) and provides a target gas information Erg. In the embodiment according to FIG. 3, the signal processing unit 50 is a component of the gas measuring unit 100, and the gas measuring unit 100 further comprises an output unit 14. The output unit 14 outputs the target gas information Erg visually and/or acoustically and/or haptically (by vibrations). As an example, the output unit 14 visually displays the target gas information Erg that the gas sample has a target gas Zg1 with the concentration con1 and another target gas Zg2 with the concentration con2. This signal processing unit 50 is described in more detail below.

In the embodiment examples, the signal processing unit 50 comprises at least one processor and the following functional components, which are preferably configured as software programs that run on the processor while the gas measuring device is being used:
a cross-correlator 6,
an optional smoothing unit 7,
a transformer 8,
an optional filter unit 9 and
an analysis unit 10.

The cross-correlator 6 calculates an indicator for the cross-correlation ρ_{xy}=ρ_{xy}(τ) between the input signal x(t) and the output signal y(t). The cross-correlation ρ_{xy}(τ) describes the similarity between the two signals x(t) and y(t). It is known that the cross-correlation ρ_{xy}(τ) in the time domain is calculated according to the formula

$${ρ}_{xt} ( τ ) = \begin{matrix}lim \\ T \to ∞\end{matrix} \frac{1}{T} {{\int }_{- T / 2}}^{+ T / 2} x ( t ) y ( t + τ ) dt . \qquad ( 1 )$$

The output signal y(t) of a linear time-invariant system is known to be related to the input signal x(t) by the so-called impulse response g(t), namely according to the formula

$$y ( t ) = g ( t ) * x ( t ) = {{\int }_{- ∞}}^{+ ∞} g ( u ) x ( t - u ) du \qquad ( 2 )$$

Here, g(t)*x(t) is the convolution between the two signals g(t) and x(t).

The cross-correlation ρ_{xy}(τ) is known to be related to the impulse response g(t) according to the formula

$${ρ}_{xt} ( τ ) = {{\int }_{- ∞}}^{+ ∞} g ( u ) {ρ}_{xx} ( τ - u ) du . \qquad ( 3 )$$

Here, ρₓₓ is the autocorrelation function of the input signal x(t).

Based on these correlations, the extractor 7 generates the impulse response g(t) from the cross-correlation ρ_{xy}(τ).

The transformer 8 transforms the impulse response g(t) from the time domain into the frequency domain, in this example by means of a Laplace transformation. This Laplace transformation is used to calculate the transfer function G(s) of the impulse response g(t). As is known, the Laplace transformation of the impulse response g(t) is calculated according to the following calculation rule:

$$G ( s ) = \{ g ( t ) \} = {{\int }_{- ∞}}^{+ ∞} g ( t ) exp ( - s t ) dt \qquad ( 4 )$$

with s=σ+jω, where σ is the real part, j is the imaginary part and ω=2πf is the angular frequency. The imaginary part jω describes the angular frequency as a complex variable.

In an alternative implementation, the following relationship is used to calculate the transfer function G(s):

$$G ( s ) = \frac{\{ y ( t ) \}}{\{ x ( t ) \}} . \qquad ( 5 )$$

In this configuration, the Laplace transform of the reference signal x(t) and the Laplace transform of the measurement signal y(t) are calculated. This configuration avoids the need to calculate a cross-correlation.

The optional filter unit 9 calculates a filtered transfer function G_{f}(s) from the transfer function G(s).

The analysis unit 10 analyzes the transfer function G(s) or the filtered transfer function G_{f}(s). In particular, it determines the amplitude response and the phase response. Depending on the phase response, the analysis unit 10 determines which target gases are present in the gas sample Gp. Depending on the amplitude response, the analysis unit 10 determines at least the summed concentrations of the target gases, preferably the respective concentration of each detected target gas.

In one embodiment, a type of zero-point signal is calculated in advance and used during use. For this purpose, a condition is created in advance in which the measurement chamber 2 and the reference chamber 3 are free from every target gas, are filled with the same gas, for example both with the reference gas Rg, or both have approximately a vacuum.

In one embodiment, as described above, a transfer function is calculated in advance in which the two chambers 2 and 3 have the same known state. This provides a zero-point transfer function G_{Null}(s). A transfer function G(s) is then calculated during use. To determine the type and/or concentration of the target gas or each target gas present, the zero-point corrected transfer function is used, e.g. the difference G(s)−G_{Null}(s).

In the embodiment shown in FIG. 3, the signal processing unit 50 is a component of the gas measuring unit 100, and the gas measuring unit 100 comprises an output unit 14 on which the target gas information Erg is output in a form that can be perceived by a human. FIG. 4 shows a deviating embodiment in which the gas measuring unit 100 does not necessarily comprise a powerful signal processing unit 50 or its own output unit 14. FIG. 4 shows:
the gas measuring unit 100, which comprises the components shown in FIG. 3 except the signal processing unit 50 as well as a housing 12 and a first communication unit 15,
a further gas measuring unit 100.1, which is constructed in the same way as the gas measuring unit 100 and also comprises a radiation source 1.1, two chambers 2.1 and 3.1, two detectors 4.1 and 5.1, a housing 12.1 and a communication unit 15.1, and
a computer unit 110, which comprises the signal processing unit 50 as well as an output computer 55 and a second communication unit 16.

The two gas measuring units 100, 100.1 are positioned, for example, at different positions in a spatial area B to be monitored. They can be connected to a stationary power supply network, or each have their own power supply unit.

The signal processing unit 50 is thus arranged at a spatial distance from the gas measuring units 100, 100.1. The communication unit 15 transmits the input signal x(t) and the output signal y(t) from the gas measuring unit 100 to the communication unit 16. In the implementation shown, the communication unit 15 transmits wirelessly messages to the communication unit 16. It is also possible that the communication units 15 and 16 are in data communication via a wired connection. Accordingly, the communication unit 15.1 transmits the input signal x.1(t) and the output signal y.1(t) from the gas measuring unit 100.1 to the same communication unit 16 of the computer unit 110.

The signal processing unit 50 of the computer unit 110 thus calculates the target gas information Erg as described above with reference to FIG. 3. The output computer 55 outputs the target gas information Erg. In the same way, the output computer 55 is also capable of outputting target gas information from the further gas measuring unit 100.1. This embodiment makes it possible to provide a very powerful signal processing unit 50. This unit 50 can be a component of a stationary computer.

While specific embodiments of the invention have been shown and described in detail to illustrate the application of the principles of the invention, it will be understood that the invention may be embodied otherwise without departing from such principles.

List of reference characters

| | |
|---|---|
| 1 | Radiation source, emits radiation eW into both chambers 2 and 3, the |
| | intensity of which is described by the excitation signal s(t) |
| 2 | Measurement chamber, takes up the gas sample Gp |
| 3 | Reference chamber, takes up the reference gas Rg |
| 4 | Measurement detector at measurement chamber 2, provides the time- |
| | resolved measuring signal y(t) |
| 5 | Reference detector at the reference chamber 3, provides the time- |
| | resolved reference signal x(t) |
| 6 | Cross-correlator, calculates the cross-correlation ρ_{xy}(t) |
| | between the reference signal x(t) and the measurement signal y(t) |
| 7 | Extractor, generates the impulse response g(t) from the cross-correlation |
| | ρ_{xy}(t) |
| 8 | Transformer, transforms the impulse response g(t) from the time domain |
| | into the frequency domain, provides the transformation result G(s) |
| 9 | Filter unit, generates the filtered transfer function G_{f}(s) |
| | from the transfer function G(s) |
| 10 | Analysis unit, analyzes the filtered transfer function G_{f}(s) in the frequency |
| | domain and provides the target gas information Erg |
| 12 | Housing of the gas measuring device 100 |
| 14 | Output unit of the gas measuring device 100 or the computer unit 110, |
| | outputs the target gas information Erg visually and/or acoustically and/ |
| | or haptically |
| 15 | Communication unit of the gas measuring device (unit) 100 |
| 15.1 | Communication unit of the gas measuring device (unit) 100.1 |
| 16 | Communication unit of the computer unit 110 |
| 50 | Signal processing unit, comprises the cross-correlator 6, the smoothing |
| | unit 7, the transformer 8, the optional filter unit 9 and the analysis unit 10, |
| | belongs in one embodiment to the gas measuring unit 100 and in another |
| | embodiment to the computer unit 110 |
| 55 | Output computer with screen, displays the target gas information Erg |
| 100 | Gas measuring device (also referred to as gas measuring unit), comprises |
| | the measurement chamber 2, the reference chamber 3, the measurement |
| | detector 4, the reference detector 5, the radiation source 1, the housing 12, |
| | in one embodiment the signal processing unit 50 and in another |
| | embodiment the communication unit 15 |
| 100.1 | Further gas measuring device (also referred to as gas measuring unit), |
| | comprises the measurement chamber 2.1, the reference chamber 3.1, the |
| | measurement detector 4.1, the reference detector 5.1, the radiation source |
| | 1.1 and the housing 12.1 |
| 110 | Remote computer unit, comprising the signal processing unit 50, the |
| | output computer 55 and the communication unit 16, connected to the gas |
| | measuring units 100 and 100.1 |
| B | Spatial area to be monitored, can have at least one target gas Zg, Zg1, Zg2 |
| Erg | Target gas information obtained by the gas measuring device 100, 50 |
| eW | Electromagnetic or acoustic radiation emitted by the radiation source 1 |
| | both into the measurement chamber 2 and into the reference chamber 3 |
| Gp | Gas sample in measurement chamber 2, comes from the area to be |
| | monitored B |
| g(t) | Impulse response in the time domain, is generated by extractor 7 from the |
| | cross-correlation ρ_{xy}(t) |
| G(s) | Transfer function of the system that supplies the measurement signal y(t) |
| | in response to an excitation by the reference signal x(t) is supplied by the |
| | transformer 8 |
| G_{f}(s) | Filtered transfer function in the frequency range, supplied by the optional |
| | filter unit 9 |
| G_{Null}(s) | Zero-point transfer function, is calculated once in advance for a state free |
| | of target gas |
| ρₓₓ(t) | Autocorrelation of the reference signal x(t) |
| ρ_{xy}(t) | Cross-correlation in the time domain between the reference signal x(t) and |
| | the measurement signal y(t), calculated by the cross-correlator 6 |
| Rg | Reference gas in reference chamber 3, free of any target gas |
| s(t) | Excitation signal describing the time-varying intensity of the radiation eW |
| | emitted by the radiation source 1 both into the measurement chamber 2 |
| | and into the reference chamber 3 |
| s₁(t) | Signal describing the intensity of the radiation eW after penetrating the |
| | reference chamber 3 |
| s₂(t) | Signal describing the intensity of the radiation eW after penetrating the |
| | measurement chamber 2 |
| x(t) | Time-resolved reference signal, supplied by the reference detector 5 |
| y(t) | Time-resolved measurement signal, supplied by the measurement |
| | detector 4 |
| Zg | Target gas |

What is claimed is:

1. A gas measuring device for analyzing a gas sample from a spatial area for several target gases to be detected, the gas measuring device comprising:
a gas measuring unit; and
a signal processing unit,
wherein the gas measuring unit comprises:
a measurement chamber;
a reference chamber;
a radiation source;
a measurement detector; and
a reference detector,
wherein the measurement chamber is configured to receive the gas sample from the spatial area,
wherein the reference chamber is filled with a reference gas which is free of every target gas to be detected,
wherein the radiation source is configured to emit radiation both into the measurement chamber and into the reference chamber such that emitted radiation penetrates at least once both the measurement chamber and the reference chamber,
wherein the measurement chamber and the reference chamber are arranged in parallel with respect to the radiation,
wherein a frequency band of the emitted radiation comprises for every target gas to be detected a respective frequency band portion in which this target gas attenuates at least a part of the radiation,
wherein the measurement detector is configured to generate a time-resolved measurement signal, which signal is an indicator of an intensity of the emitted radiation, after the radiation has penetrated at least once at least a part of the gas sample in the measurement chamber,
wherein the reference detector is configured to generate a time-resolved reference signal, which signal is an indicator of an intensity of the emitted radiation after the radiation has penetrated at least once at least a part of the reference gas in the reference chamber,
wherein the signal processing unit is configured to calculate an indicator for a system behavior in the time domain or in the frequency domain of a system,
wherein said system is excited with the reference signal as the input signal, and said system generates in response to said excitation the measurement signal as the output signal,
wherein the signal processing unit is configured to determine a target gas information by evaluating the calculated indicator for the system behavior, and
wherein the determined target gas information comprises at least one of:
an indicator of a sum of target gases concentrations in the gas sample of the target gases to be detected;
what target gas is present or which target gases are present in the gas sample; and
for at least one target gas an indicator of a respective quantity or concentration of this target gas in the gas sample.

2. A gas measuring device according to claim 1,
wherein the signal processing unit comprises a cross-correlator,
wherein the cross-correlator is configured to calculate the cross-correlation in the time domain between the reference signal and the measurement signal, and
wherein the signal processing unit is configured to calculate the indicator for the system behavior using at least one of the cross-correlation in the time domain or a result of a transformation of the cross-correlation into the frequency domain.

3. A gas measuring device according to claim 1, wherein the signal processing unit is configured to calculate in the frequency domain a transfer function of the system and wherein the signal processing unit is configured to calculate the indicator for the system behavior using the transfer function in the frequency domain or to use the transfer function in the frequency domain as the indicator for the system behavior.

4. A gas measuring device according to claim 1, further comprising:
a computer unit,
wherein the gas measuring unit comprises a first communication unit,
wherein the computer unit is located spatially remote from the gas measuring unit and comprises a second communication unit,
wherein the signal processing unit is a component of the computer unit, and
wherein the gas measuring unit is configured to transmit the measurement signal and the reference signal from the gas measuring unit to the signal processing unit using the two communication units.

5. A gas measuring device according to claim 4,
wherein the gas measuring device is configured to transmit the target gas information to the gas measuring unit by using the two communication units wherein the signal processing unit has calculated the target gas information as a function of the transmitted measurement signal and the transmitted reference signal, and
wherein the gas measuring device is configured to generate a message depending on the received target gas information and output the generated message in at least one form that can be perceived by a human.

6. A gas measuring device according to claim 4, wherein the gas measuring unit comprises an evaluation unit, the evaluation unit being configured:
to measure, as a function of the measurement signal and of the reference signal, an indicator of an attenuation which at least one of the target gases to be detected cause in the measurement chamber; and
depending on the determined attenuation value, to decide whether or not the gas sample contains this target gas.

7. A gas detection process for analyzing a gas sample from a spatial area for several target gases to be detected, the process comprising:
providing a gas measuring unit which comprises: a measurement chamber; a reference chamber; a radiation source; a measurement detector; and a reference detector, wherein the reference chamber is filled with a reference gas which is free of every target gas to be detected, the measurement chamber is filled with the gas sample;
with the radiation source, emitting radiation both into the measurement chamber and into the reference chamber such that emitted radiation penetrates at least once each both chambers, wherein the two chambers are arranged in parallel with respect to the radiation, wherein a frequency band of the emitted radiation comprises for every target gas to be detected a respective frequency band portion in which the target gas attenuates at least a part of the radiation;
with the measurement detector, generating a time-resolved measurement signal, which signal is an indicator of an intensity of the emitted radiation, after the radiation has penetrated at least once at least a part of the gas sample in the measurement chamber;
with the reference detector, generating a time-resolved reference signal, which signal is an indicator of an intensity of the emitted radiation, after the radiation has penetrated at least once at least a part of the reference gas in the reference chamber;
calculating an indicator for a system behavior in the time domain or in the frequency domain of a system, wherein said system is excited with the reference signal as the input signal and said system generates the measurement signal as the output signal in response to the excitation, and
determining target gas information by evaluating the calculated indicator for the system behavior,
wherein the target gas information comprises at least one of:
an indicator of a sum of target gas concentrations in the gas sample of the target gases to be detected;
which target gases are present in the gas sample; and
for at least one target gas an indicator of a respective quantity or concentration of this target gas in the gas sample.

8. A gas detection process according to claim 7, wherein the step of calculating the indicator for the system behavior comprises calculating a cross-correlation in the time domain between the reference signal and the measurement signal.

9. A gas detection process according to claim 8, wherein the step of calculating the indicator for the system behavior comprises the steps of:
transforming the cross-correlation into the frequency domain; and
determining the indicator for the system behavior using the cross-correlation result of the transformation of the cross-correlation into the frequency domain.

10. A gas detection process according to claim 8,
wherein the radiation source emits the radiation with white noise, and
wherein using the result of the transformation of the cross-correlation into the frequency domain, the transfer function of the system is calculated when excited by the input signal, and the indicator for the system behavior is calculated using the transfer function.

11. A gas detection process according to claim 7, wherein prior to using the gas measuring unit for detecting target gas or detecting target gases, the measurement chamber is filled with a reference gas sample from the spatial area, the reference gas sample being free of any target gas, and as a zero-point system behavior indicator, the zero-point system behavior indicator is calculated using the reference gas sample and during use of the gas measuring unit for target gas or target gases detecting, and the zero point system behavior indicator is subtracted from the system behavior indicator.

12. A gas detection process according to claim 7,
wherein a set of target gases to be detected is predetermined,
wherein for every target gas of the set of target gases and for at least one predetermined concentration of this target gas:
the measurement chamber is filled with a gas sample which contains the target gas at the specified concentration and is free from the or every other target gas;
the system behavior indicator is determined using the gas sample which contains the target gas at the specified concentration to provide a reference system behavior indicator for the target gas; and
the reference system behavior indicator for the target gas is used when determining the target gas concentrations.

13. A gas detection process according to claim 7, wherein a gas sample from the spatial area is used as the reference gas, which is free of the or each target gas to be detected.
